(19) United States
(12) Patent Application Publication
(10) Pub. No.: US 2025/0245498 A1
(43) Pub. Date: Jul. 31, 2025

(54) TRAINING NEURAL NETWORKS USING WEIGHT NORM REGULARIZATIONS

(71) Applicant: DeepMind Technologies Limited, London (GB)

(72) Inventor: Andrew Brock, London (GB)

(21) Appl. No.: 18/424,672

(22) Filed: Jan. 26, 2024

(51) Int. Cl. G06N 3/08; G06N 3/04

(52) U.S. Cl. CPC G06N 3/08; G06N 3/04

(57) ABSTRACT

Methods, systems, and apparatus, including computer programs encoded on computer storage media, for training a neural network. One of the methods includes, for a weight tensor that includes weights of the neural network: performing, using a plurality of training examples, a training step to obtain respective gradients of a loss function with respect to the weights in the weight tensor; applying an optimizer to the respective gradients to generate respective gradient-based updates to the weights in the weight tensor; applying the respective gradient-based updates to the weights in the weight tensor to generate initial updated values of the weights in the weight tensor; scaling the initial updated values of the weights in the weight tensor to generate scaled updated values that have a predetermined target norm; and setting current values of the weights in the weight tensor for a next training step to be equal to the scaled updated values.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of weights.

### SUMMARY

This specification generally describes a system that trains a neural network to perform a machine learning task.

The neural network is configured to perform the machine learning task by processing a network input in accordance with a set of weights of the neural network to generate a network output for the machine learning task. For example, the weights of the neural network include weights and, optionally, biases of the layers of the neural network.

During the training, the system updates the weights of the neural network at each of multiple update iterations. In particular, the system updates the weights such that the weights for each layer of the neural network will always have a fixed norm at the end of each update iteration.

In general, one innovative aspect of the subject matter described in this specification can be embodied in a method of training a neural network, wherein the method comprises repeatedly performing the following for a weight tensor that includes weights of the neural network: performing, using a plurality of training examples, a training step to obtain respective gradients of a loss function with respect to the weights in the weight tensor; applying an optimizer to the respective gradients to generate respective gradient-based updates to the weights in the weight tensor; applying the respective gradient-based updates to the weights in the weight tensor to generate initial updated values of the weights in the weight tensor; scaling the initial updated values of the weights in the weight tensor to generate scaled updated values that have a predetermined target norm; and setting current values of the weights in the weight tensor for a next training step to be equal to the scaled updated values.

Applying the respective gradient-based updates to the weights in the weight tensor may comprise applying the respective gradient-based updates to the weights in the weight tensor without applying any weight decay updates to the weights in the weight tensor.

The weights in the weight tensor may be associated with a particular layer of the neural network, and wherein the particular layer may include no biases.

Training the neural network may comprise, for the weight tensor that includes the weights of the neural network: determining a fan-in value of the weight tensor, the fan-in value representing a total number of input values on which the weights in the weight tensor are to be applied; and determining initial values of the weights in the weight tensor based on the fan-in value and a predetermined distribution.

Training the neural network may comprise: determining the predetermined target norm based on the fan-in value of the weight tensor.

Applying the optimizer to the respective gradients to generate respective gradient-based updates may comprise, for each weight in the weight tensor: computing the respective gradient-based update to the weight based on one or more moments for the weight.

Computing the respective gradient-based update to the weight based on one or more moments for the weight may comprise: computing a square root over a difference between one and a square of a first exponential decay rate; updating a first moment based on the square root; and computing the respective gradient-based update to the weight based on the updated first moment.

Computing the square root over the difference between one and the square of the first exponential decay rate may comprise: determining a value of the first exponential decay rate based on a predetermined schedule.

The neural network may comprise a Transformer neural network and the weights in the weight tensor may be associated with an attention layer of the Transformer neural network.

Training the neural network may comprise: training the neural network to perform (i) a text processing task, (ii) an image processing task, (iii) an audio processing task, (iv) a video processing task, or (v) a multi-modal task involving two or more of (i)-(iv).

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

Particular embodiments of the subject matter described in this specification can be implemented so as to realize one or more of the following advantages. State of the art neural networks have a large number of weights and therefore are prone to unstable training caused by the distribution of a given layer's weights changing during training. Unstable training results in inferior performance of the trained neural network, and increases consumption of computing resources, e.g., memory and computing power, of the training process.

A training system can use the techniques described in this specification to improve the stability of the training of a neural network, e.g., to reduce early training oscillations, by constraining the weights for each layer of the neural network to always have a fixed norm at the end of each update iteration during the training process. This may allow higher learning rates to be effectively used during training, which may result in more rapid weight updates and reduced consumption of computing resources because fewer update iterations will be needed.

The training system can also use the techniques described in this specification to initialize the weights of the neural network in a way that facilitates a more effective training process by mitigating gradient explosion and vanishing problems. Exploding or vanishing gradients might cause numerical overflow or irregular training oscillations which inhibit successful training of the neural network.

The training system can therefore train a neural network more quickly and by using fewer computing resources than some existing conventional systems. The savings in computing resources can be especially significant for large-scale neural networks that are harder to train due to their immense numbers of weights. Once trained, the neural network can achieve or even exceed the state-of-the-art on any of a variety of tasks, despite a training process that consumes fewer computing resources, is faster in terms of wall-clock time, or both, than conventional systems that do not use such techniques,

Advantageously, constraining the weights to have fixed norm may reduce the need for other regularization techniques, e.g., weight decay, as well as the hyperparameter tuning processes that are required to use those regularization techniques, to be employed during training. For example, a hyperparameter tuning process that is otherwise needed to adapt the weight decay as certain aspects of training process (e.g., batch size, number of update iterations, neural network architecture, and so on) change, and that is tedious, complicated, computationally expensive, and hard to scale, can be avoided.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network training system.

FIG. 2 is a flow diagram of an example process for updating a weight tensor of a neural network.

FIG. 3 is a flow diagram of sub-steps of one of the steps of the process of FIG. 2.

FIG. 4 is an example illustration of scaling the initial updated values of the weights of a neural network.

Like reference numbers and designations in the various drawings indicate like elements.

### DETAILED DESCRIPTION

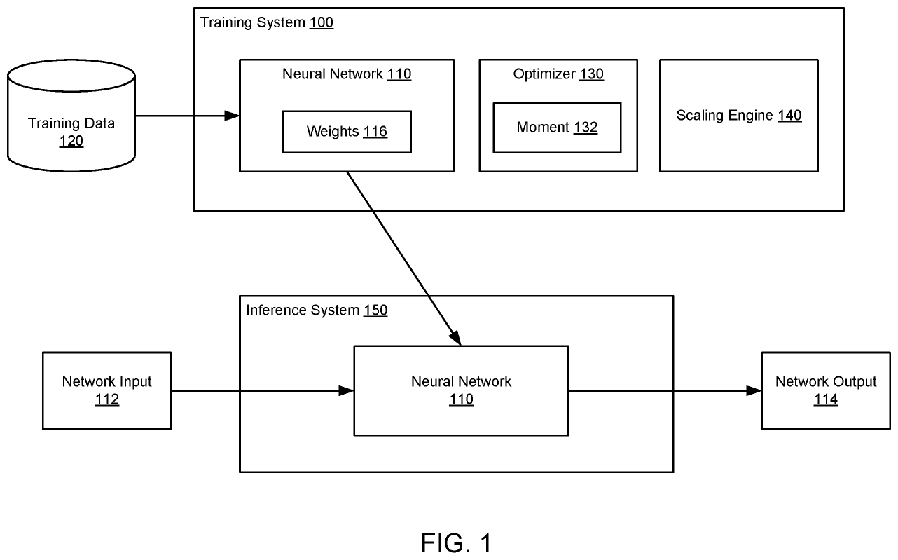

FIG. 1 shows an example neural network training system 100. The system 100 is an example of a system implemented as computer programs on one or more computers in one or more locations, in which the systems, components, and techniques described below can be implemented.

The training system 100 is a system that trains a neural network 110 on training data 120 to perform a machine learning task.

The neural network 110 is configured to perform the machine learning task by processing a network input in accordance with a set of weights 116 of the neural network 110 to generate a network output for the machine learning task.

The neural network 110 can be trained to perform any kind of machine learning task, i.e., can be configured to receive any kind of digital data input and to generate any kind of score, classification, or regression output based on the input.

Some examples of machine learning tasks the neural network 110 can be configured to perform follow. In implementations the neural network 110 can be configured as, or include, a generative (large) language model or a multi-modal model, e.g., a visual and language model, to perform these example machine learning tasks.

In some cases, the neural network 110 is a neural network that is configured to perform an image or video processing task, i.e., receive an input image or an input video having multiple frames (where each frame is an input image) and to process the intensity values of the pixels of the input image to generate a network output for the input image or the input video.

For example, the task may be image classification and the output generated by the neural network 110 for a given image may be scores for each of a set of object categories, with each score representing an estimated likelihood that the image contains an image of an object belonging to the category. As another example, the task can be image embedding generation and the output generated by the neural network 110 can be a numeric embedding of the input image. As yet another example, the task can be object detection and the output generated by the neural network 110 can identify locations in the input image at which particular types of objects are depicted. As yet another example, the task can be image semantic segmentation and the output generated by the neural network 110 can assign each pixel of the input image to a category from a set of categories. As yet another example, the task can be image instance segmentation and the output generated by the neural network 110 can assign each pixel of the input image to a respective object instance from a set of object instances. As yet another example, the task can be image depth prediction and the output generated by the neural network 110 can assign a respective predicted depth value to each pixel of the input image.

As another example, if the inputs to the neural network 110 are Internet resources (e.g., web pages), documents, or portions of documents or features extracted from Internet resources, documents, or portions of documents, the task can be to classify the resource or document, i.e., the output generated by the neural network 110 for a given Internet resource, document, or portion of a document may be a score for each of a set of topics, with each score representing an estimated likelihood that the Internet resource, document, or document portion is about the topic.

As another example, if the inputs to the neural network 110 are features of an impression context for a particular advertisement, the output generated by the neural network 110 may be a score that represents an estimated likelihood that the particular advertisement will be clicked on.

As another example, if the inputs to the neural network 110 are features of a personalized recommendation for a user, e.g., features characterizing the context for the recommendation, e.g., features characterizing previous actions taken by the user, the output generated by the neural network 110 may be a score for each of a set of content items, with each score representing an estimated likelihood that the user will respond favorably to being recommended the content item.

As another example, if the input to the neural network 110 is a sequence of text in one language, the output generated by the neural network 110 may be a piece of text in the other language that is a predicted proper translation of the input text into the other language.

Some implementations may be used for automatic code generation. For example the input may represent words, wordpieces or characters in a first natural language and the output may represent instructions in a computer programming or markup language, or instructions for controlling an application program to perform a task e.g. build a data item such as an image or web page.

As another example, the task may be an audio processing task. For example, if the input to the neural network 110 is a sequence representing a spoken utterance, the output generated by the neural network 110 may be a text transcript for the utterance. As another example, the task may be a keyword spotting task where, if the input to the neural network 110 is a sequence representing a spoken utterance, the output generated by the neural network 110 can indicate whether a particular word or phrase (“hotword”) was spoken in the utterance. As another example, if the input to the neural network 110 is a sequence representing a spoken utterance, the output generated by the neural network 110 can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image or a video, and the output can be text that describes the input.

In some implementations the input represents data to be compressed, e.g. image data, video data, text data, audio data, or any other type of data; and the output a compressed version of the data. The input and output may each comprise any representation of the data to be compressed/compressed data e.g. symbols or embeddings generated/decoded by a respective neural network.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the neural network 110 may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network 110 to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network 110 may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g. a video camera system) may be provided for monitoring the action (if any) which the user actually performs at each time step, in case (e.g. due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network 110, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv:2209.14375) or Chinchilla (Hoffmann et al. arXiv:2203.15556). The digital assistant can have an observation capture subsystem to capture visual and/or audio observations of the user performing a task; and an interface for the above-described language model neural network 110 (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network 110 includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

The neural network 110 can generally have any appropriate architecture for performing the machine learning task. Examples of neural network architectures that the neural network 110 can have include convolutional architectures, recurrent architectures, fully-connected architecture, e.g., multi-layer perceptron (MLP) architectures, generative (large) language model or multi-modal model architectures, e.g., encoder-only Transformer architectures, encoder-decoder Transformer architectures, decoder-only Transformer architectures, other attention-based architectures, and so on.

Generally, however, the neural network 110 includes multiple layers that each have respective weights 116. For each layer, the respective weights 116 can be represented as a tensor (a “weight tensor”), and can include weights and, optionally, biases of the layer.

Each of the multiple layers is configured to receive a layer input and apply the respective weights 116 for the layer to the layer input to generate the layer output of the layer, and then provide the layer output to one or more other layers of the neural network that are configured to receive input from the layer according to the neural network architecture.

How the layer applies the weights to the layer input depends on the type of neural network layer.

For example, a convolutional layer computes a convolution between the weights and the layer input.

As another example, a fully-connected layer computes a product between the weights of the layer and the layer input, and, when the respective weights 116 for the fully-connected layer includes biases, adds the biases to the product. Alternatively, when the respective weights 116 for the fully-connected layer does not include biases, the fully-connected layer computes a product between the weights of the layer and the layer input, but adds no bias to the product.

As yet another example, an attention layer applies an attention mechanism over the layer input, where the attention mechanism uses keys, queries, and values that are computed based on the weights of the attention layer.

The neural network 110 can have additional layers and components that do not have weights, e.g., normalization layers, pooling layers, residual connections, softmax layers, logistic layers, and so on.

In a particular example, the neural network 110 can have an architecture of a decoder-only Transformer neural network. When having such an architecture, the neural network 110 can be configured to auto-regressively generate an output sequence made up of tokens selected from a predetermined vocabulary of tokens.

In this example, the multiple layers of the neural network 110 include a sequence of attention layers, where each attention layer is configured to receive as input a respective current representation of each of the tokens in a current output sequence and to process the respective current representations to generate as output a respective updated representation of each of the tokens in the current output sequence. For example, each attention layer can apply a causally masked self-attention mechanism over the respective current representations to generate the respective updated representations.

A self-attention mechanism over the respective current representations refers to an attention mechanism that computes queries, keys, and values from the respective current representations.

A causally masked self-attention mechanism over the respective current representations refers to an attention mechanism in which any given position in the current text sequence does not attend over, i.e., does not have a non-zero attention weight for, any positions after the given position in the current text sequence.

Each attention layer can optionally apply other operations to the representations as part of updating the representations, e.g., by making use of a position-wise feed-forward neural network, by applying layer normalization, by making use of residual connections, and so on.

In this example, the weights 116 of the neural network 110 can include at least (i) the weights of each attention layer in the sequence of attention layers, e.g., the weights of one or more query transformation layers, the weights of one or more key transformation layers, and the weights of one or more value transformation layers within an attention layer, and (ii) the weights of each feed-forward layer included in each position-wise feed-forward neural network. The weights 116 of the neural network 110 can also include the weights of an embedding layer of the neural network 110 that is configured to generate the embeddings of the tokens in the current output sequence.

The training system 100 trains the neural network 110 on training data 120 to repeatedly update the values of the weights 116 the neural network 110, i.e., to generate trained values of the weights 116 from initial values.

The training data 120 includes multiple training examples which, in turn, each include a training input and a corresponding target output for the training input for the machine learning task, i.e., a target output to be generated by the neural network 110 by processing the training input.

Generally, the system 100 trains the neural network 110 to minimize a loss function for the machine learning task.

The loss function can be any appropriate loss function for the machine learning task. Generally, however, the loss function includes one or more terms that measure, for each training input, the quality of a training output for the training input generated by performing a forward pass through the neural network, e.g., relative to a respective target output for the training input. For example, the one or more terms can be cross entropy loss terms, mean squared error loss terms, negative log likelihood loss terms, and so on.

The loss function can also include other terms, e.g., regularization terms, auxiliary loss terms, unsupervised learning loss terms, and so on, that do not depend on the target outputs for the training inputs.

More specifically, the training system 100 performs the training over a plurality of update iterations. At each update iteration, the training system 100 updates the weights of the neural network 110 using a plurality of training examples (a “batch” or a “mini-batch” of training examples) sampled from the training data 120.

Thus, by repeatedly performing update iterations, the training system 100 repeatedly updates the values of the weights 116 of the neural network 110 to determine trained values of the weights 116 that will cause the neural network 110 to perform well on the machine learning task.

More specifically, at each update iteration, the training system 100 computes, using the plurality of training examples, a gradient of the loss function for the machine learning task with respect to each of the weights 116 of the neural network 110.

The training system 100 then uses an optimizer 130 and a scaling engine 140 to determine an update to the values of the weights 116 of the neural network 110 from the gradients.

For each weight tensor of a layer of the neural network 110, the optimizer 130 generates, based on the respective gradient each of the weight included in the weight tensor, a respective gradient-based update. The respective gradient-based updates are applied to the current values of the weights in the weight tensor to generate initial updated values of the weights in the weight tensor as of the update iteration.

The optimizer 130 can be an optimizer that uses any of a variety of known update rules. An update rule specifies how the gradients computed during an update iteration of the neural network training procedure is used to update the current values of the weights 116 of the neural network, i.e., to update the values of the weights 116 of the neural network as of that update iteration.

For example, the optimizer 130 can be an Adam optimizer (that uses an Adam update rule). As another example, the optimizer 130 can be a RMSProp optimizer. As another example, the optimizer 130 can be a LARS optimizer. As another example, the optimizer 130 can be an Adafactor optimizer. As yet another example, the optimizer 130 can be a Lamb optimizer. These examples are not intended to be limiting.

In some cases, the optimizer 130 uses an update rule that does not apply weight decay updates to the weights 116, or the optimizer 130 disables weight decay when computing the respective gradient-based updates to the weights 116 of the neural network.

That is, in some cases, weight decay is no longer needed because of how the values of the weights 116 of the neural network 110 are updated at each update iteration. Whereas some existing update rules apply weight decay updates to improve training stability and prevent overfitting, weight decay updates could slow down the learning rate, make the weights of the neural network converge slower, and require more update iterations.

In some cases, for each weight, the optimizer 130 keeps track of one or more moments 132 of the gradient of the loss function with respect to the weight across the update iterations, and, at each update iteration, calculates the update to the weights from the gradients and the tracked moments 132.

The moments 132 add history to weights updates. In various cases, a moment value of 0 may be equivalent to a gradient-based update without moment. A higher moment value means more gradients from the past (history) are considered in the current update iteration. One example of such a moment is the mean of the gradients (the gradients of the loss function with respect to the weight that is updated at every update iteration). Another example of such a moment is the variance of the gradients.

For each weight tensor, after having generated the initial updated values of the weights in the weight tensor, the scaling engine 140 scales the initial updated values of the weights in the weight tensor by a scaling factor to generate scaled updated values as of the update iteration.

In particular, the scaled updated values will have a predetermined target norm. As such, the scaling engine 140 constrains the weight tensor of each of the multiple layers of the neural network 110 to always have a fixed norm at the end of each update iteration. This improves stability of training, and, in some cases, removes the need for other regularization techniques, such as weight decay and associated schedules.

Because the initial updated values for each weight tensor that are generated as a result of applying the optimizer 130 to the respective gradients may, and typically will, vary across the plurality of update iterations, the scaling factor is not fixed to any specific value, and the scaling engine 140 can set the scaling factor to different values for different update iterations, and for different weight tensors of different layers of the neural network 110.

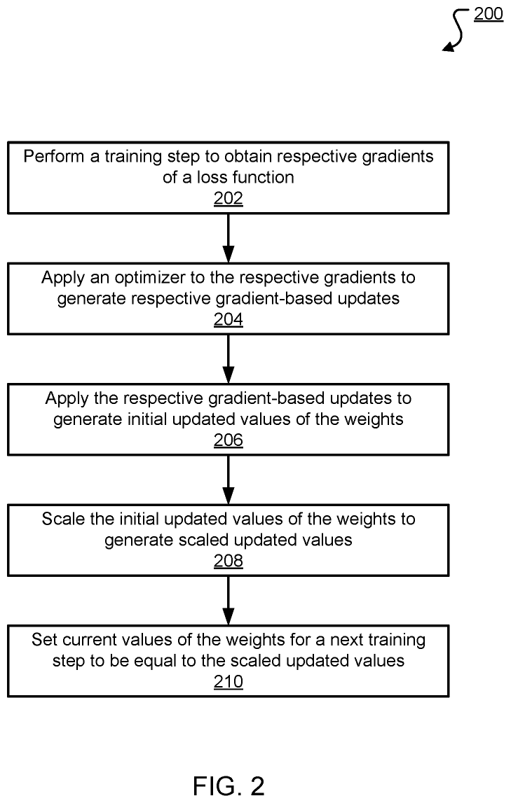

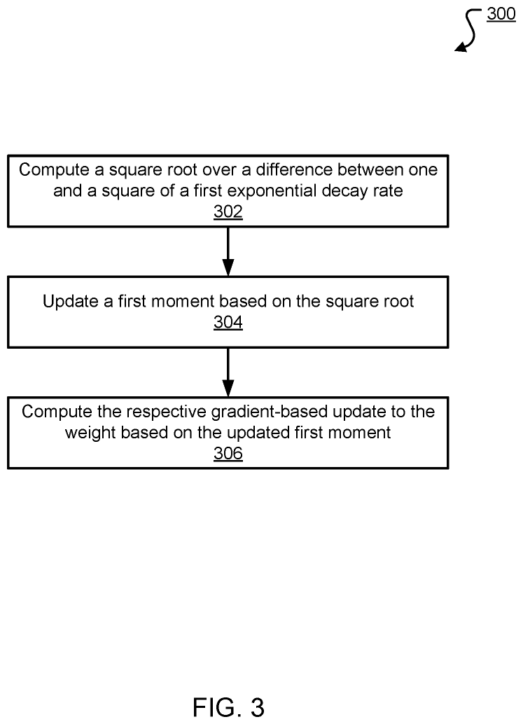

Updating the values of the weights 116 at each update iteration is described in more detail below with reference to FIGS. 2 and 3.

After training, the training system 100 or a different inference system 150 deploys the trained neural network 110 on one or more computing devices to perform inference, i.e., to generate new network outputs 114 for the machine learning task for new network inputs 112. Optionally, the training system 100 or the different inference system 150 can further fine-tune some or all of the weights 116 of the neural network 110 before deploying the neural network 110, e.g., using a different optimizer or on a different loss function.

FIG. 2 is a flow diagram of an example process 200 for updating a weight tensor of a neural network. The weight tensor can include the weights of a layer of the neural network. For convenience, the process 200 will be described as being performed by a system of one or more computers located in one or more locations. For example, a training system, e.g., the training system 100 of FIG. 1, appropriately programmed, can perform the process 200.

To train the neural network, the system can repeatedly perform iterations of the process 200 to repeatedly update the respective weight tensor of each of multiple layers of the neural network until a termination criterion has been satisfied, e.g., until a threshold number of iterations of the process 200 have been performed, until a threshold amount of wall clock time has elapsed, or until the values of the weights included in the respective weight tensors have converged.

Prior to beginning training, i.e., prior to performing any iterations of the process 200, the system initializes the values of the weights included in the respective weight tensor of each of the multiple layers of the neural network. In some cases, the system can do this by setting the value for each weight included in the respective weight tensor to a pre-defined initial value, e.g., a zero value. In other cases, the system can do this by randomly sampling a value for each weight included in the respective weight tensor from a predetermined distribution.

As a particular example of this, the predetermined distribution can be a normal distribution with a zero mean and a variance equal to 1/\sqrt{fan-in}, where fan-in is the total number of incoming layer connections, i.e., the total number of input values on which the weights in the weight tensor are to be applied. In this example, the value for each weight wᵢ included in the weight tensor can be determined as: wᵢ˜N (0, 1/\sqrt{fan-in}).

The system performs, using a plurality of training examples, a training step to obtain respective gradients of a loss function with respect to the weights in the weight tensor (step 202). Each training example includes a training input and a target output for each training input. The system will generally obtain different training examples at different iterations, e.g., by sampling a fixed number of examples from a larger set of training data at each iteration.

For example, the system can perform a forward pass through the neural network using the training examples and then perform a backward pass through the neural network to compute the respective gradients through backpropagation.

As described above, the loss function can be any appropriate loss function for the machine learning task. Generally, the loss function includes one or more terms that measure, for each training input, the quality of a training output for the training input generated by performing a forward pass through the neural network, e.g., relative to a respective target output for the training input. For example, the one or more terms can be cross entropy loss terms, mean squared error loss terms, negative log likelihood loss terms, and so on.

The loss function can also include other terms, e.g., regularization terms, auxiliary loss terms, unsupervised learning loss terms, and so on, that do not depend on the target outputs for the training inputs.

The system applies an optimizer to the respective gradients to generate respective gradient-based updates to the weights in the weight tensor (step 204). The optimizer can use any of a variety of known update rules to determine how the respective gradients are used to update the values of the weights included in the weight tensor. For example, the optimizer can be an Adam optimizer (that uses an Adam update rule), a RMSProp optimizer, a LARS optimizer, an Adafactor optimizer, a Lamb optimizer, or the like.

In some cases, the system uses an optimizer that, for each weight, keeps track of one or more moments for the weight and calculates the update to the weights from the gradients and the tracked moments.

As a particular example of this, the optimizer can be a particular variant of the Adam optimizer that uses a corrected moment. The Adam optimizer can have the following hyperparameters: a learning rate or step size (often represented by α); the exponential decay rate β₁ for the first moment moving average; the exponential decay rate β₂ for the second moment moving average; and an epsilon term ϵ, e.g., used to prevent division by zero. The Adam optimizer can perform the following computations to apply the gradient-based update to a weight:

$$\begin{matrix}{m}_{t} ← {β}_{1} \cdot {m}_{t - 1} + ( 1 - {β}_{1} ) \cdot {g}_{t} \\ {v}_{t} ← {β}_{2} \cdot {v}_{t - 1} + ( 1 - {β}_{2} ) \cdot {g}_{t}^{2} \\ {\hat{m}}_{t} ← {m}_{t} / ( 1 - {β}_{1}^{t} ) \\ {\hat{v}}_{t} ← {v}_{t} / ( 1 - {β}_{2}^{t} ) \\ {θ}_{t} ← {θ}_{t - 1} - α \cdot {\hat{m}}_{t} / ( \sqrt{{\hat{v}}_{t}} + ϵ )\end{matrix}$$

where mₜ is the exponential moving average of the first moment of the gradients of the weight, vₜ is the exponential moving average of the second moment of the gradients of the weight, gₜ is the gradient of the weight from the current update iteration, θₜ₋₁ is the current value for the weight, and θₜ is the initial updated value for the weight.

To use the corrected moment, the particular variant of the Adam optimizer computes the exponential moving average of the first moment of the gradients of the weight as:

$${m}_{c} ← {β}_{1} \cdot {m}_{t - 1} + \sqrt{1 - {β}_{1}^{2}} \cdot {g}_{t}$$

instead of:

$${m}_{t} ← {β}_{1} \cdot {m}_{t - 1} + ( 1 - {β}_{1} ) \cdot {g}_{t}$$

In this particular example, the particular variant of the Adam optimizer can in some cases begin with a starting exponential decay rate β₁ of 0.95 which is later decreased to 0.9 over the course of training. In other cases, a different exponential decay schedule can be used. Computing the moment in this way disentangles the exponential decay rate β₁ from the learning rate (which otherwise have to be jointly tuned in the Adam update rule), and allows them to be tuned or scheduled separately.

One example way of applying such a particular variant of the Adam optimizer to the respective gradients to generate respective gradient-based updates to the weights in the weight tensor is explained in more detail with reference to FIG. 3, which shows sub-steps 302-306 of the step 204.

The system computes a square root over a difference between one and a square of an exponential decay rate β₁ for the first moment moving average (step 302). That is, the system computes \sqrt{1−β₁²}. For example the system can determine the value of the exponential decay rate β₁ based on a predetermined schedule. The predetermined schedule may be a schedule in which the exponential decay rate β₁ decreases from a first (e.g., larger) value over the plurality of iterations of the process 200 to a second (e.g., smaller) value.

The system updates the first moment of the gradients of the weight based on the square root (step 304). The system can do this by computing:

$${m}_{t} ← {β}_{1} \cdot {m}_{t - 1} + \sqrt{1 - {β}_{1}^{2}} \cdot {g}_{t}$$

where mₜ is the exponential moving average of the first moment of the gradients of the weight, and gₜ is the gradient of the weight from the current update iteration.

The system computes the respective gradient-based update to the weight based on the updated first moment (step 306). The system can do this by evaluating the equations explained above for the Adam optimizer beginning from line 2.

The system applies the respective gradient-based updates to the weights in the weight tensor, e.g., by subtracting the respective gradient-based updates from current values of the weights in the weight tensor, to generate initial updated values of the weights in the weight tensor (step 206).

The system scales the initial updated values of the weights in the weight tensor to generate scaled updated values of the weights in the weight tensor (step 208). To scale the initial updated values of the weights to generate the scaled updated values, the system can use a scaling factor, e.g., by multiplying each weight in the weight tensor by the scaling factor.

In particular, the scaled updated values of the weights in the weight tensor will have a predetermined target norm, i.e., have a norm that is equal to a predetermined target value. In some cases, the predetermined target value is the same for different weight tensors of different layers in the neural network. In other cases, different weight tensors of different layers in the neural network will have different predetermined target norms.

For example, for a weight tensor of a given layer, the predetermined target value can be based on the fan-in value of the given layer, the fan-out value of the given layer, or both the fan-in and fan-out values. As a particular example of this, the predetermined target value can be defined in the form of a ratio of the fan-out value to the fan-in value. The fan-out value is the total number of outgoing layer connections, i.e., the total number of output values generated as a result of applying the weight tensor to the input values.

The norm of the weight tensor can be calculated in any way. For example, the norm can be calculated as a maximum norm (that outputs the maximum of the absolute values of the initial updated values of the weights in the weight tensor). As another example, the norm can be calculated as a L1 norm. As another example, the norm can be calculated as a L2 norm. As another example, the norm can be calculated as a L_{∞} norm. As yet another example, the norm can be calculated as a Frobenius norm.

Because the initial updated values for the weight tensor that are generated in step 206 may, and typically will, vary across different iterations of the process 200, the scaling factor used to scale the initial updated values is not fixed to any specific value, and the system can set the scaling factor to different values for different update iterations, and for different weight tensors.

Moreover, in fact, the way the system determines the scaling factor may vary depending on how the norm of the weight tensor is calculated.

For example, when the norm is calculated as a maximum norm, the system can determine the scaling factor by dividing the predetermined target value by the maximum of the absolute values of the initial updated values of the weights in the weight tensor.

As another example, when the norm is calculated as a Frobenius norm, the system can determine the value of scaling factor c by solving the following equation:

$${Norm}_{target} = \sqrt{{( {cw}_{1} )}^{2} + {( {cw}_{2} )}^{2} + … + {( {cw}_{n} )}^{2} )} ,$$

where w₁, w₂, . . . , wₙ are weights in the weight tensor, the Norm_{target} is the predetermined target value of the norm of the weight tensor.

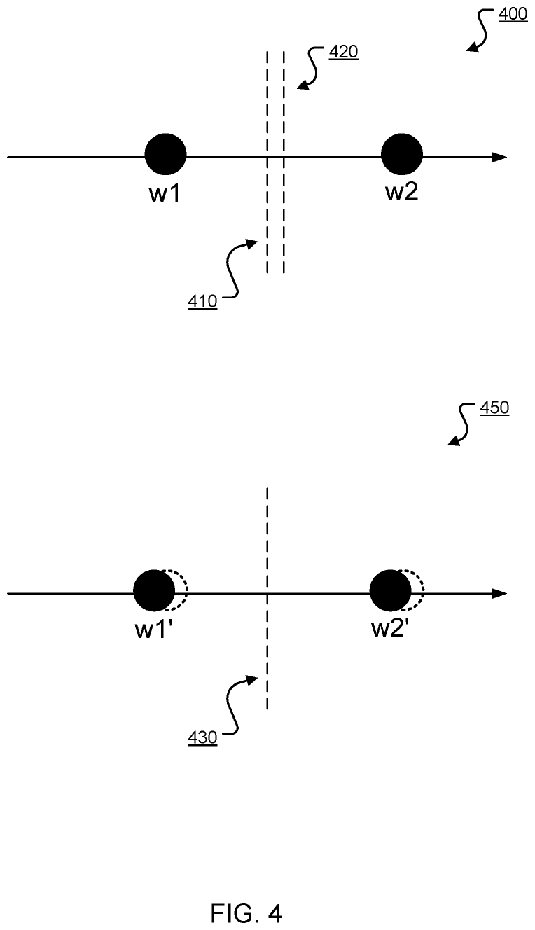

FIG. 4 is an example illustration of scaling the initial updated values of the weights of a neural network. At 400, FIG. 4 illustrates a first dot representing a first weight value w₁, a second dot representing a second weight value w₂, a first line 410 representing the predetermined target norm of the weight values, and a second line 420 representing an initial norm of the first weight value w₁ and the second weight value w₂. In FIG. 4, the initial norm is different from, i.e., greater in magnitude than, the predetermined target norm. At 450, FIG. 4 illustrates a first dot representing a scaled first weight value w₁′ and a second dot representing a scaled second weight value w₂′ that can be generated from the first weight value w₁ and the second weight value w₂ based on applying a scaling factor, respectively, and a line 430 representing a scaled norm of the scaled first weight value w₁′ and the scaled second weight value w₂′. Unlike the initial norm, the scaled norm is now the same as the predetermined target norm.

The system sets current values of the weights in the weight tensor for a next training step to be equal to the scaled updated values (step 210). Thus, the next iteration of the process 200 will begin from the scaled updated values of the weights in the weight tensor that have been determined in step 208 in the current iteration of the process 200.

For example, in step 202 of the next iteration of the process 200, after obtaining the plurality of training examples, the system will perform the forward pass through the neural network using the training examples in accordance with the scaled updated values of the weights in the weight tensor that have been determined as of the current iteration of the process 200.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network, wherein the method comprises repeatedly performing the following for a weight tensor that includes weights of the neural network:
performing, using a plurality of training examples, a training step to obtain respective gradients of a loss function with respect to the weights in the weight tensor;
applying an optimizer to the respective gradients to generate respective gradient-based updates to the weights in the weight tensor;
applying the respective gradient-based updates to the weights in the weight tensor to generate initial updated values of the weights in the weight tensor;
scaling the initial updated values of the weights in the weight tensor to generate scaled updated values that have a predetermined target norm; and
setting current values of the weights in the weight tensor for a next training step to be equal to the scaled updated values.

2. The method of claim 1, wherein applying the respective gradient-based updates to the weights in the weight tensor comprises applying the respective gradient-based updates to the weights in the weight tensor without applying any weight decay updates to the weights in the weight tensor.

3. The method of claim 1, wherein the weights in the weight tensor are associated with a particular layer of the neural network, and wherein the particular layer includes no biases.

4. The method of claim 1, wherein training the neural network comprises, for the weight tensor that includes the weights of the neural network:
determining a fan-in value of the weight tensor, the fan-in value representing a total number of input values on which the weights in the weight tensor are to be applied; and
determining initial values of the weights in the weight tensor based on the fan-in value and a predetermined distribution.

5. The method of claim 4, wherein training the neural network comprises:
determining the predetermined target norm based on the fan-in value of the weight tensor.

6. The method of claim 1, wherein applying the optimizer to the respective gradients to generate respective gradient-based updates comprises, for each weight in the weight tensor:
computing the respective gradient-based update to the weight based on one or more moments for the weight.

7. The method of claim 6, wherein computing the respective gradient-based update to the weight based on one or more moments for the weight comprises:
computing a square root over a difference between one and a square of a first exponential decay rate;
updating a first moment based on the square root; and
computing the respective gradient-based update to the weight based on the updated first moment.

8. The method of claim 7, wherein computing the square root over the difference between one and the square of the first exponential decay rate comprises:
determining a value of the first exponential decay rate based on a predetermined schedule.

9. The method of claim 1, wherein the neural network comprises a Transformer neural network and the weights in the weight tensor are associated with an attention layer of the Transformer neural network.

10. The method of claim 1, wherein training the neural network comprises:
training the neural network to perform (i) a text processing task, (ii) an image processing task, (iii) an audio processing task, (iv) a video processing task, or (v) a multi-modal task involving two or more of (i)-(iv).

11. A system comprising one or more computers and one or more storage devices storing instructions that when executed by one or more computers cause the one or more computers to perform operations for training a neural network, wherein the operations comprise repeatedly performing the following for a weight tensor that includes weights of the neural network:
performing, using a plurality of training examples, a training step to obtain respective gradients of a loss function with respect to the weights in the weight tensor;
applying an optimizer to the respective gradients to generate respective gradient-based updates to the weights in the weight tensor;
applying the respective gradient-based updates to the weights in the weight tensor to generate initial updated values of the weights in the weight tensor;
scaling the initial updated values of the weights in the weight tensor to generate scaled updated values that have a predetermined target norm; and
setting current values of the weights in the weight tensor for a next training step to be equal to the scaled updated values.

12. The system of claim 11, wherein applying the respective gradient-based updates to the weights in the weight tensor comprises applying the respective gradient-based updates to the weights in the weight tensor without applying any weight decay updates to the weights in the weight tensor.

13. The system of claim 11, wherein the weights in the weight tensor are associated with a particular layer of the neural network, and wherein the particular layer includes no biases.

14. The system of claim 11, wherein training the neural network comprises, for the weight tensor that includes the weights of the neural network:
determining a fan-in value of the weight tensor, the fan-in value representing a total number of input values on which the weights in the weight tensor are to be applied; and
determining initial values of the weights in the weight tensor based on the fan-in value and a predetermined distribution.

15. The system of claim 14, wherein training the neural network comprises:
determining the predetermined target norm based on the fan-in value of the weight tensor.

16. The system of claim 11, wherein applying the optimizer to the respective gradients to generate respective gradient-based updates comprises, for each weight in the weight tensor:
computing the respective gradient-based update to the weight based on one or more moments for the weight.

17. The system of claim 16, wherein computing the respective gradient-based update to the weight based on one or more moments for the weight comprises:
computing a square root over a difference between one and a square of a first exponential decay rate;
updating a first moment based on the square root; and
computing the respective gradient-based update to the weight based on the updated first moment.

18. The system of claim 17, wherein computing the square root over the difference between one and the square of the first exponential decay rate comprises:
determining a value of the first exponential decay rate based on a predetermined schedule.

19. The system of claim 11, wherein the neural network comprises a Transformer neural network and the weights in the weight tensor are associated with an attention layer of the Transformer neural network.

20. One or more computer-readable storage media storing instructions that when executed by one or more computers cause the one or more computers to perform operations for training a neural network, wherein the operations comprise repeatedly performing the following for a weight tensor that includes weights of the neural network:
performing, using a plurality of training examples, a training step to obtain respective gradients of a loss function with respect to the weights in the weight tensor;
applying an optimizer to the respective gradients to generate respective gradient-based updates to the weights in the weight tensor;
applying the respective gradient-based updates to the weights in the weight tensor to generate initial updated values of the weights in the weight tensor;
scaling the initial updated values of the weights in the weight tensor to generate scaled updated values that have a predetermined target norm; and
setting current values of the weights in the weight tensor for a next training step to be equal to the scaled updated values.
